(19) United States
(12) Patent Application Publication
(10) Pub. No.: US 2018/0164930 A1
(43) Pub. Date: Jun. 14, 2018

(54) INPUT DEVICE, OPERATION METHOD OF INPUT DEVICE, AND ELECTRONIC DEVICE CORRESPONDING TO INPUT DEVICE

(71) Applicant: WideVantage Inc., Gangnam-gu Seoul (KR)

(72) Inventor: Jae Yong Goh, Seocho-gu Seoul (KR)

(73) Assignee: WideVantage Inc., Gangnam-gu Seoul (KR)

(21) Appl. No.: 15/578,669

(22) PCT Filed: Jan. 29, 2016
(86) PCT No.: PCT/KR2016/000968

§ 371 Date: Nov. 30, 2017

(30) Foreign Application Priority Data
Jun. 2, 2015 (KR) 10-2015-0078257
Jun. 16, 2015 (KR) 10-2015-0084900
Jul. 10, 2015 (KR) 10-2015-0098540
Sep. 22, 2015 (KR) 10-2015-0133741
Oct. 1, 2015 (KR) 10-2015-0138828
Jan. 29, 2016 (KR) 10-2016-0011132

(51) Int. Cl. G06F 3/041; G06F 3/0488

(52) U.S. Cl. CPC G06F 3/0412; G06F 3/0416; G06F 3/04886

(57) ABSTRACT

Disclosed are an input device, an operation method of an input device, and an electronic device corresponding to the input device. The disclosed input device is located on the outside of a touch screen included in an electronic device, and comprises a first conductive material in which a change in electrical properties occurs on the basis of a touch inputted from a user; and a second conductive material which is electrically connected to the first conductive material and transfers a change in electrical properties to a predetermined position on the touch screen.

### TECHNICAL FIELD

Example embodiments relate to an input device, an operation method of the input device, and an electronic device corresponding to the input device.

### BACKGROUND ART

Due to a recent increase in portable electronic devices such as smartphones, smart pads, tablet computers, and the like, there is also an increasing demand from users for an instinctive or intuitive input and/or output method. For such portable electronic devices, portability may a permanent issue of concern. For the portability of an electronic device, a size thereof may be restricted, and thus a size of a touchscreen configured to display information and receive a touch input from a user may be relatively smaller than that of a general television (TV) and monitor.

However, due to such a limited size of the touchscreen, the user may experience inconvenience in making an input to the electronic device, despite the improved portability of the electronic device.

### DISCLOSURE

### Technical Goals

An aspect provides a device and method using an input device configured to transfer an electrical property change occurring by a user touching a touchscreen of an electronic device to the touchscreen may minimize a screen occlusion occurring due to such a touch input to the touchscreen and facilitate an input to the electronic device through the input device that is not affected by a limited or small touchscreen of the electronic device.

Another aspect also provides a device and method that may electrically connect a first conductive material disposed outside a touchscreen of an electronic device and configured to receive a touch input from a user and a second conductive material disposed on the touchscreen, and thus may simply substitute for a high-cost system requiring a connection of, for example, a Bluetooth, a sensor, a circuit, a power supply, and the like.

Still another aspect also provides a device and method that may simply operate a pointing device, a joystick device, a dial device, and a button device without a high cost for an additional connection of a sensor, a circuit, a power supply, and the like, by using an input device having a centrally regressive characteristic based on a magnetic force between a movable magnetic portion and a stationary magnetic portion and configured to generate a magnetic field change pattern based on a movement of the movable magnetic portion, and may also facilitate attachment and detachment to and from an electronic device.

Yet another aspect also provides a device and method that may provide a user with tactile feedback through a centrally regressive characteristic based on a magnetic force between a movable magnetic portion and a stationary magnetic portion, and allow the user to readily recognize a force and a direction of a movement of the movable magnetic portion without a visual verification of such.

### Technical Solutions

According to an example embodiment, there is provided an input device corresponding to an electronic device, the input device including a first conductive material disposed outside a touchscreen included in the electronic device and configured to generate an electrical property change based on a touch input by a user, and a second conductive material electrically connected to the first conductive material and configured to transfer the electrical property change to a predetermined location on the touchscreen.

The input device may further include an inputter including a button coming into contact with a portion of a body of the user, and configured to electrically connect the user and the first conductive material in response to an input through the button by the user.

The input device may further include an inputter including a button coming into contact with a portion of the body of the user, and configured to electrically connect the first conductive material and a ground portion of the electronic device in response to an input through the button by the user.

The first conductive material may be disposed on a side face or a back face of the electronic device on which the touchscreen is not provided to receive a touch input from the user.

The first conductive material may be disposed in a button included in a keyboard-type inputter.

The first conductive material may be disposed in a radial structure corresponding to an object movement direction indicated on the touchscreen.

The input device may further include an inputter having a centrally regressive characteristic, and configured to receive an instruction on the object movement direction indicated on the touchscreen from the user and transfer the received instruction to the first conductive material, and provide the user with tactile feedback based on the instruction on the object movement direction.

The inputter may include a stationary magnetic portion electrically connected to the first conductive material, and a movable magnetic portion having a centrally regressive characteristic based on a magnetic force with the stationary magnetic portion and configured to transfer the instruction on the object movement direction input by the user to the stationary magnetic portion.

The input device may include a stationary element electrically connected to the first conductive material, and a movable element having a centrally regressive characteristic based on an elastic member, for example, a spring and a rubber band, to return to a central axis of the stationary element and configured to transfer the instruction on the object movement direction input by the user to the stationary element.

The second conductive material may be provided as a transparent conductor.

According to another example embodiment, there is provided an input device corresponding to an electronic device, the input device including a movable magnetic portion having a centrally regressive characteristic based on a magnetic force with a stationary magnetic portion fixed to the electronic device, and configured to generate a magnetic field change pattern to be transferred to the electronic device based on a movement induced by a user.

The stationary magnetic portion may be a magnetic portion attached to a housing of the electronic device or a magnetic portion embedded in the electronic device.

The movable magnetic portion may oscillate with respect to the stationary magnetic portion based on the movement induced by the user and generate the magnetic field change pattern based on the oscillation.

The movable magnetic portion and the stationary magnetic portion may be disposed in parallel to each other, and vertically or horizontally magnetized to generate an attractive force therebetween.

The movable magnetic portion may include a first sub-magnetic portion configured to share a central axis with the stationary magnetic portion, and a second sub-magnetic portion configured not to share a central axis with the stationary magnetic portion. The movable magnetic portion may generate the magnetic field change pattern based on a rotational movement of the second sub-magnetic portion with respect to the stationary magnetic portion.

According to still another example embodiment, there is provided an electronic device including a touchscreen configured to detect an electrical property change through a second conductive material attached to the touchscreen of the electronic device, and a processor configured to control an operation of the electronic device based on the electrical property change. The second conductive material may be electrically connected to a first conductive material disposed outside the touchscreen and configured to generate the electrical property change based on a touch input by a user.

The first conductive material may be disposed in a radial structure corresponding to an object movement direction indicated on the touchscreen.

When the electrical property change corresponds to a preset touch pattern input by the user, the processor may unlock the electronic device based on the electrical property change.

According to yet another example embodiment, there is provided an electronic device including a sensor configured to sense a magnetic field change pattern generated in an input device based on a movement induced by a user, and a processor configured to control an operation of the electronic device based on the magnetic field change pattern. The input device may include a movable magnetic portion having a centrally regressive characteristic based on a magnetic force with a stationary magnetic portion fixed to the electronic device.

When the magnetic field change pattern corresponds to a preset pattern input by the user, the processor may unlock the electronic device based on the magnetic field change pattern.

The preset pattern may include at least one of an object movement direction indicated on a touchscreen of the electronic device, a rotation of the movable magnetic portion with respect to the stationary magnetic portion, or a location change of the movable magnetic portion with respect to the stationary magnetic portion.

According to further another example embodiment, there is provided an operation method of an input device, the operation method including generating, in a first conductive material disposed outside a touchscreen included in an electronic device, an electrical property change based on a touch input by a user, and transferring, by a second conductive material configured to electrically connect the first conductive material and the touchscreen, the electrical property change to a predetermined location on the touchscreen.

The operation method may further include electrically connecting the user and the first conductive material, when an input is received from the user through a button coming into contact with a portion of a body of the user.

The first conductive material may be disposed in a radial structure corresponding to an object movement direction indicated on the touchscreen.

According to still another example embodiment, there is provided an operation method of an input device corresponding to an electronic device, the operation method including generating, in a movable magnetic portion having a centrally regressive characteristic based on a magnetic force with a stationary magnetic portion fixed to the electronic device, a magnetic field change pattern to be transferred to the electronic device, based on a movement induced by a user.

The generating of the magnetic field change pattern may include generating the magnetic field change pattern based on the movable magnetic portion configured to oscillate with respect to the stationary magnetic portion based on the movement induced by the user.

### Advantageous Effects

According to example embodiments described herein, using an input device configured to transfer, to a touchscreen of an electronic device, an electrical property change generated by a touch input by a user touching the touchscreen, a screen occlusion occurring due to such a touch input to the touchscreen may be minimized, and also an input to the electronic device may be facilitated without being affected by a limited or small touchscreen of the electronic device.

According to example embodiments described herein, an electrical connection between a first conductive material disposed outside a touchscreen and configured to receive a touch input from a user and a second conductive material disposed in the touchscreen may simply substitute for a high-cost system requiring a connection of, for example, a Bluetooth, a sensor, a circuit, a power supply, and the like.

According to example embodiments described herein, an input device having a centrally regressive characteristic based on a magnetic force between a movable magnetic portion and a stationary magnetic portion and configured to generate a magnetic field changing pattern based on a movement of the movable magnetic portion may enable an implementation or an operation of a pointing device, a joystick device, a dial device, and a button device without a high cost for an additional connection of a sensor, a circuit, a power supply, and the like, and also may facilitate an easy attachment and detachment to and from an electronic device.

According to example embodiments described herein, by providing a user with tactile feedback through a centrally regressive characteristic based on a magnetic force between a movable magnetic portion and a stationary magnetic portion, the user may readily recognize a force and a direction of a movement of the movable magnetic portion without a visual verification.

### BRIEF DESCRIPTION OF DRAWINGS

FIGS. 1A and 1B are diagrams illustrating examples of an electronic device and an input device according to an example embodiment.

FIGS. 2A and 2B are diagrams illustrating examples of an input device according to an example embodiment.

FIG. 3 is a diagram illustrating an example of an input device using a magnetic field according to an example embodiment.

FIGS. 4A and 4B are diagrams illustrating another example of an input device using a magnetic field according to an example embodiment.

FIG. 5 is a diagram illustrating still another example of an input device using a magnetic field according to an example embodiment.

FIG. 6 is a diagram illustrating an example of an input device further including an inputter according to an example embodiment.

FIG. 7 is a diagram illustrating another example of an input device further including an inputter according to an example embodiment.

FIGS. 8A and 8B are diagrams illustrating an example of an inputter included in an input device according to an example embodiment.

FIGS. 9A through 9C are diagrams illustrating an example of an operation method of an input device according to an example embodiment.

FIGS. 10A and 10B are diagrams illustrating another example of an operation method of an input device according to an example embodiment.

FIGS. 11A through 11C are diagrams illustrating still another example of an operation method of an input device according to an example embodiment.

FIG. 12 is a diagram illustrating yet another example of an operation method of an input device according to an example embodiment.

FIGS. 13 and 14 are flowcharts illustrating examples of an operation method of an input device according to an example embodiment.

### BEST MODE FOR CARRYING OUT THE INVENTION

The following detailed description is provided to assist the reader in gaining a comprehensive understanding of the methods, apparatuses, and/or systems described herein. The features described herein may be embodied in different forms, and are not to be construed as being limited to example embodiments described herein. Rather, the example embodiments described herein have been provided merely to illustrate some of the many possible ways of implementing the methods, apparatuses, and/or systems described herein that will be apparent after an understanding of the disclosure of this application.

Terms such as first, second, A, B, (a), (b), and the like may be used herein to describe components. Each of these terminologies is not used to define an essence, order, or sequence of a corresponding component but used merely to distinguish the corresponding component from other component(s). For example, a first component may be referred to as a second component, and similarly the second component may also be referred to as the first component.

It should be noted that if it is described in the specification that one component is “connected,” “coupled,” or “joined” to another component, a third component may be “connected,” “coupled,” and “joined” between the first and second components, although the first component may be directly connected, coupled or joined to the second component.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, operations, elements, and/or components, but do not preclude the presence or addition of one or more other features, integers, operations, elements, components, and/or groups thereof.

Unless otherwise defined, all terms, including technical and scientific terms, used herein have the same meaning as commonly understood by one of ordinary skill in the art to which this disclosure pertains based on an understanding of the present disclosure. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

Example embodiments to be described hereinafter may be applied to transfer, to an electronic device, a user command or instruction that is input to an input device. The example embodiments may be applied to transfer a user command or instruction to various types of electronic devices, for example, a smartphone, a smart pad, a wearable device, a tablet computer, a personal computer (PC), a laptop computer, a smart home appliance, and the like. Hereinafter, the example embodiments will be described in detail by referring to the accompanying drawings, wherein like reference numerals refer to the like elements throughout.

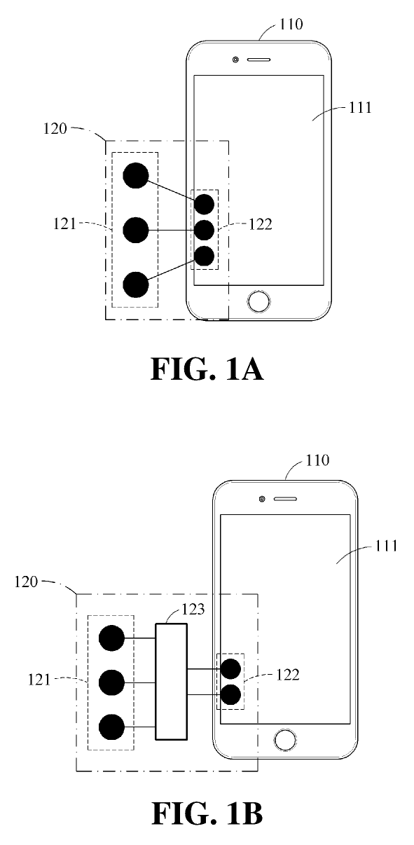

FIGS. 1a and 1b are diagrams illustrating examples of an electronic device and an input device according to an example embodiment.

FIG. 1a illustrates an electronic device 110 and an input device 120.

The electronic device 110 includes a touchscreen 111 and a processor. The touchscreen 111 may display a screen thereon, and detect a touch input to the touchscreen. For example, the touchscreen 111 may detect a change in an electrical property, or simply referred to herein as an electrical property change, for example, a capacitance change, that is generated by a touch input to the touchscreen 111, and measure a location of an object being in contact with the touchscreen 111. In response to the electrical property change, the processor may control an operation of the electronic device 110.

In addition, the electronic device 110 includes a housing that covers a bezel on a front face including the touchscreen 111, and a back face and a side face on which the touchscreen 111 is not provided.

The input device 120 includes a first conductive material 121 and a second conductive material 122.

The first conductive material 121 may be disposed outside the touchscreen 111, for example, on the housing of the electronic device 110, and generate an electrical property change in response to a touch input by a user.

The second conductive material 122 may be disposed at a predetermined location on the touchscreen 111, and electrically connected to the first conductive material 121 to transfer, to a predetermined location on the touchscreen 111, the electrical property change received from the first conductive material 121.

The user may touch the first conductive material 121 disposed outside the touchscreen 111, without a need to directly touch the touchscreen 111. In general, a human body may be conductive, and thus the electrical property change may occur when a portion of a body of the user touches the first conductive material 121. The electrical property change generated in the first conductive material 121 may be transferred to the touchscreen 111 through the second conductive material 122, and the electronic device 110 may then perform an operation in response to the electrical property change.

The first conductive material 121 and the second conductive material 122 may be disposed at a plurality of locations. That is, a plurality of first conductive materials 121 may be disposed at different locations outside the touchscreen 111, and a plurality of second conductive materials 122 corresponding to the plurality of first conductive materials 121 may be disposed at different locations on the touchscreen 111. The first conductive materials 121 and the second conductive materials 122 may correspond to each other, and thus the electronic device 110 may identify a touch input by the user to the first conductive material 121 based on a location of the second conductive material 122 to which the electrical property change is transferred.

For example, the input device 120 may be an external keyboard attached to the touchscreen of the electronic device 110, and each of the first conductive materials 121 may correspond to each key or button on the external keyboard to which the user directly input a touch input with a finger of the user. Each of the second conductive materials 122 may be electrically connected to each key or button corresponding to each of the first conductive materials 121 and transfer the touch input to the touchscreen 111.

The first conductive materials 121 disposed at different locations may be connected through a nonconductor therebetween in order to prevent a current flow therebetween. Alternatively, the first conductive materials 121 disposed at different locations may be connected through a material having a lower conductivity than the first conductive materials 121 to prevent a current flow therebetween. In addition, the first conductive materials 121 may be designed to have different electrical properties, for example, capacitances, from each other. The details described in the foregoing may be applicable to the second conductive materials 122 disposed at different locations.

Referring to FIG. 1b, the input device 120 further includes a circuit 123.

As the number of the first conductive materials 121 disposed at different locations increases, the number of the second conductive materials 122 disposed on the touchscreen 111 may also increase and a size of an area occupied by the second conductive materials 122 may also increase. Here, to prevent an input and output area of the touchscreen 111 from decreasing when the size of the area of the touchscreen 111 occupied by the second conductive materials 122 increases, the circuit 123 may be further included in the input device 120 to transfer an electrical property change to at least one of the second conductive materials 122 when one of the first conductive materials 121 is touched.

For example, the circuit 123 may electrically connect m first conductive materials 121 and n second conductive materials 122, in which m may be greater than n (m>n). The circuit 123 may transfer, to the n second conductive materials 122, different electrical property changes, for example, capacitances and electrical resistances, that are generated in the m first conductive materials 121 in response to a touch input.

The circuit 123 may determine electrical property vectors O1, O2, . . . , On to be transferred to the n second conductive materials 122 disposed at different locations on the touchscreen 111, to be a function, for example, Function_Of, of electrical property vectors I1, I2, . . . , Im generated in the m first conductive materials 121 disposed at different locations outside the touchscreen 111.

(I1, I2, . . . , Im)=Function_Of(O1, O2, . . . , On) [Equation 1]

For example, in a case in which the m first conductive materials 121 are disposed at four different locations outside the touchscreen 111 and the n second conductive materials 122 are disposed at four different locations on the touchscreen 111, for example, m=4 and n=4, (I1, I2, I3, I4)=(O1, O2, O3, O4). For another example, in a case in which the m first conductive materials 121 are disposed at three different locations outside the touchscreen 111 and the n second conductive materials 122 are disposed at two different locations on the touchscreen 111, for example, m=3 and n=2, (O1, O2, O3) may be one of {(0,0,0), (1,0,0), (0,1,0), (0,0,1)} by indicating a touch input to the first conductive materials 121 as 1 and a touch input not being made as 0. Here, based on a configuration of the circuit, the function Function_Of may be defined as follows.

(0, 0)=Function_Of(0, 0, 0)

(0, 1)=Function_Of(1, 0, 0)

(1, 0)=Function_Of(0, 1, 0)

(1, 1)=Function_Of(0, 0, 1) [Equation 2]

By configuring the circuit 123 based on the foregoing, the circuit 123 may determine an electrical property change to be transferred to the second conductive material 122 based on a touch input to the first conductive material 121.

The electronic device 110 may identify a first conductive material 121 to which a touch input is input from among the first conductive materials 121 by applying an inverse function of the function Function_Of to an electrical property change detected by the touchscreen 111. The electronic device 110 may recognize which of locations of the first conductive materials 121 a touch input is made, a size of an area of the touch input, and the like, based on the electrical property change detected by the touchscreen 111.

That is, by controlling the electrical property change generated in the first conductive material 121 through the circuit 123, it is possible to further clarify the electrical property change to be transferred to the second conductive material 122.

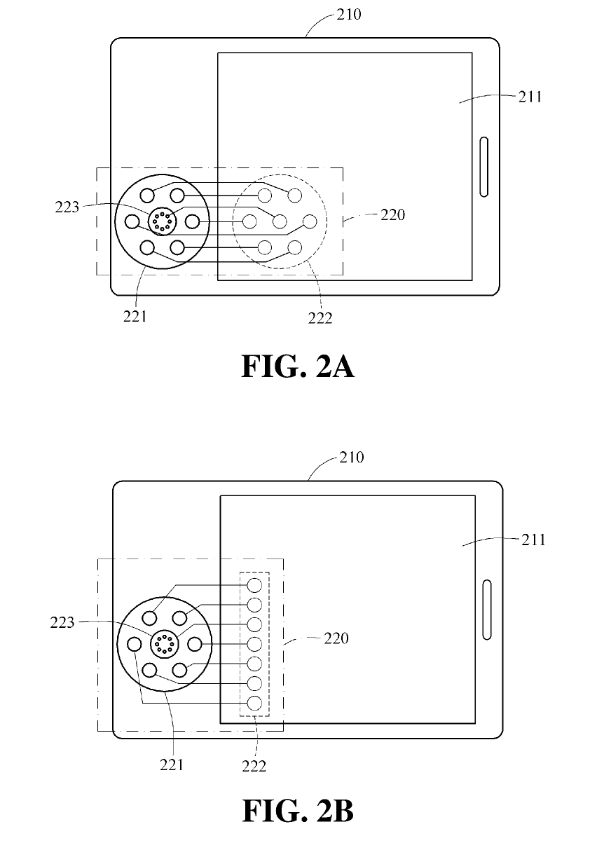

FIGS. 2a and 2b are diagrams illustrating examples of an input device according to an example embodiment.

Referring to FIG. 2a, an input device 220 includes a first conductive material 221 and a second conductive material 222.

A touchscreen 211 may display a virtual joystick to which an instruction on an object movement direction indicated on the touchscreen 211 is input. The virtual joystick may be an interface configured to control a movement of an object indicated on the touchscreen 211, and the touchscreen 211 may control a direction of the movement of the object, or simply referred to above as an object movement direction, based on a user touch detected on a portion on which the virtual joystick is displayed.

That is, the electronic device 210 may control the object movement direction indicated on the touchscreen 211 by receiving, through the touchscreen 211, the instruction on the object movement direction, for example, an upward, downward, leftward, or rightward movement, from a user touching a portion of the virtual joystick with a finger of the user. Further, the electronic device 210 may also control a speed of the movement of the object, or an object movement speed, indicated on the touchscreen 211 based on a movement distance of the virtual joystick controlled by the user.

However, the user using the virtual joystick may need to simultaneously watch the virtual joystick, in addition to the object indicated on the touchscreen 211, to recognize which portion of the virtual joystick is being touched and which direction the touched portion corresponds to. In addition, the user may need to bring a finger of the user into contact with the touchscreen 211 to use the virtual joystick, and thus a portion of the touchscreen 211 may be occluded to cause inconvenience. Thus, it may be necessary to move the virtual joystick to outside of the touchscreen 211, and provide tactile feedback of a joystick such that the user may recognize which portion is being touched and which direction the touched portion corresponds to, without a need to watch the virtual joystick.

The first conductive material 221 and the second conductive material 222 may be disposed or provided in the input device 220, in a structure similar to that of the virtual joystick displayed on the touchscreen 211. For example, the first conductive material 221 and the second conductive material 222 may be disposed to receive the instruction on the object movement direction indicated on the touchscreen 211 from the user. The first conductive material 221 and the second conductive material 222 may be disposed in a radial structure corresponding to the object movement direction.

A considerable portion of the first conductive material 221 may be disposed at a desirable location different from a location of the virtual joystick, for example, outside of the touchscreen 211, or a housing of the electronic device 210, in which a screen is less occluded than the portion on which the virtual joystick is displayed. In addition, the second conductive material 222 may be disposed on the portion of the touchscreen 211 on which the virtual joystick is displayed. The user may input the instruction on the object movement direction to the virtual joystick displayed on the touchscreen 211 through the first conductive material 221. Here, a portion on the touchscreen 211 including the second conductive material 222 may be provided as a transparent conductor, for example, indium tin oxide (ITO) and a patterned transparent film or glass, such that the user may not experience inconvenience caused when a view of the user is partially occluded by the second conductive material 222.

The user may input the instruction on the object movement direction indicated on the touchscreen 211 by moving a joystick handle portion 223 having a centrally regressive characteristic, which is a characteristic of returning to a central axis of the first conductive material 221, to deviate from the central axis of the first conductive material 221. The joystick handle portion 223 may also be provided as a conductive material, and thus the handle portion 223 may transfer a user touch input by the user to the first conductive material 221 disposed under the handle portion 223.

When the joystick handle portion 223 deviates from the central axis of the first conductive material 221 by the user, the user touch may be transferred to a first conductive material 221 corresponding to the moved handle potion 223, and an electrical property change may be generated in the first conductive material 221. The generated electrical property change may be transferred to the virtual joystick displayed on the touchscreen 211 through the second conductive material 222 electrically connected to the first conductive material 221.

Referring to FIG. 2b, the input device 220 includes a first conductive material 221 and a second conductive material 222. In such a case where a conductive area being in contact with the first conductive material 221 by the handle portion 223 or a finger of the user is sufficiently large, by simultaneously touching at least two of seven first conductive materials 221 illustrated in FIG. 2b, a multitouch may be transferred to a touchscreen 211 through the second conductive material 222. In such a case, a processor of an electronic device 210 may determine that the handle portion 223 or the finger of the user is between the simultaneously touched first conductive materials 221. Although seven conductive materials are illustrated in FIG. 2, the number of conductive materials insulated from each other may vary as necessary.

A portion of the touchscreen 211 in which the second conductive material 222 is disposed as illustrated in FIG. 2b may function as a plurality of virtual buttons. To minimize an occlusion of the touchscreen 211 by the second conductive material 222, the second conductive material 222 and the virtual buttons thereunder may be arranged in a line at an edge of the touchscreen 211. However, such an arrangement is provided for convenience of description, and an arrangement structure of the virtual buttons is not limited to the example described in the foregoing.

The second conductive materials 222 of the input device 220 may be disposed to correspond respectively to the virtual buttons. When a touch is input to a joystick-type first conductive material 221 through a handle portion 223, an electrical property change may be generated, and the generated electrical property change may be transferred to the virtual buttons indicated on the touchscreen 211 through the second conductive materials 222.

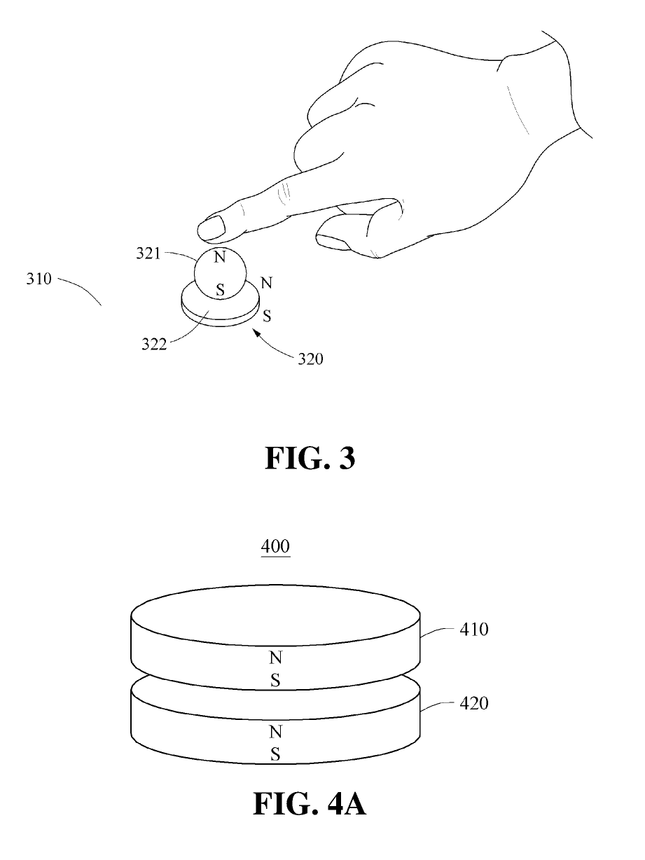

FIG. 3 is a diagram illustrating an example of an input device using a magnetic field according to an example embodiment.

Referring to FIG. 3, an input device 320 is attached to a housing 310 of an electronic device, and includes a movable magnetic portion 321 and a stationary magnetic portion 322.

The housing 310 of the electronic device refers to a portion of the electronic device excluding a touchscreen, and including, for example, a bezel on a front face of the electronic device, and a side face and a back face of the electronic device.

The movable magnetic portion 321 is a spherical magnetic portion, and has a centrally regressive characteristic based on a magnetic force with the stationary magnetic portion 322. The movable magnetic portion 321 generates a magnetic field change pattern to be transferred to the electronic device based on a movement induced by a user.

The stationary magnetic portion 322 is a flat-shaped magnetic portion, and is disposed at a location fixed to the electronic device. The stationary magnetic portion 321 applies, to the movable magnetic portion 321, an attractive force based on a magnetic field, and thus provides the centrally regressive characteristic to the movable magnetic portion 321. The stationary magnetic portion 322 may be attached to or detached from the housing 310 of the electronic device through a magnetic force or magnetism.

The user may push the movable magnetic portion 321 with a portion of a body of the user, for example, a finger and such, to induce a movement of the movable magnetic portion 321 on a two-dimensional (2D) plane based on the stationary magnetic portion 322. Due to the movement of the movable magnetic portion 321, the magnetic field change pattern may be generated in the movable magnetic portion 321, and the electronic device may detect the magnetic field change pattern and identify the movement of the movable magnetic portion 321.

Alternatively, the stationary magnetic portion 322 may be a magnetic portion embedded in the electronic device. In such a case, the input device 320 may include a single movable magnetic portion 321, and the movable magnetic portion 321 may have a centrally regressive characteristic based on a magnetic force with the stationary magnetic portion 322 embedded in the electronic device.

The magnetic force, for example, an attractive force, between the movable magnetic portion 321 and the stationary magnetic portion 322 may be weakened in proportion to the cube of a distance between the movable magnetic portion 321 and the stationary magnetic portion 322. Thus, a guide configured to restrict such a distance not to be greater than a predetermined distance may be further included such that the movable magnetic portion 321 is not separated away from the stationary magnetic portion 322 during the movement of the movable magnetic portion 321 by the user. Alternatively, to prevent such a separation, the movable magnetic portion 321 and the stationary magnetic portion 322 may be connected to each other through a nonmagnetic material. For example, the nonmagnetic material may be a rubber element that covers or wraps the movable magnetic portion 321 and the stationary magnetic portion 322, and thus may prevent the movable magnetic portion 321 from being separated from the stationary magnetic portion 322 during a movement of the movable magnetic portion 321 by the user.

For example, in a case in which the user pulls or stretches the movable magnetic portion 321 to one side while holding the movable magnetic portion 321, and then releases the movable magnetic portion 321 from that location, for example, bouncing the movable magnetic portion 321, the movable magnetic portion 321 may convert potential energy generated by a magnetic force with the stationary magnetic portion 322 to kinetic energy and move towards the stationary magnetic portion 322. The movable magnetic portion 321 may then convert again the kinetic energy to the potential energy while moving in opposite direction by the kinetic energy. While such a process is being repeated, the movable magnetic portion 321 may oscillate with respect to the stationary magnetic portion 322, and generate the magnetic field change pattern indicating oscillation of a magnetic field. The electronic device may detect the magnetic field change pattern through a sensor, and thus identify a movement of the movable magnetic portion 321. Thus, although locations of the movable magnetic portion 321 and the stationary magnetic portion 322 change with respect to the sensor of the electronic device, the oscillation of the movable magnetic portion 321 may be detected. Through such a movement of the movable magnetic portion 321, the electronic device may also identify a discrete event input of bouncing the movable magnetic portion 321 in addition to a successive input of rotating the movable magnetic portion 321.

Here, a method of oscillating the movable magnetic portion 321 may include, for example, a method of pushing, by the user, the movable magnetic portion 321 further from the stationary magnetic portion 322, a method of disposing the movable magnetic portion 321 further from the stationary magnetic portion 322 through an additional magnetic portion and then separating the additional magnetic portion and the movable magnetic portion 321 by pushing it by a hand, and a method of connecting the movable magnetic portion 321 to a base surface, or a base for a motion or movement, through a spring without the stationary magnetic portion 322 and then pushing the movable magnetic portion 321 further from the base surface, and the like.

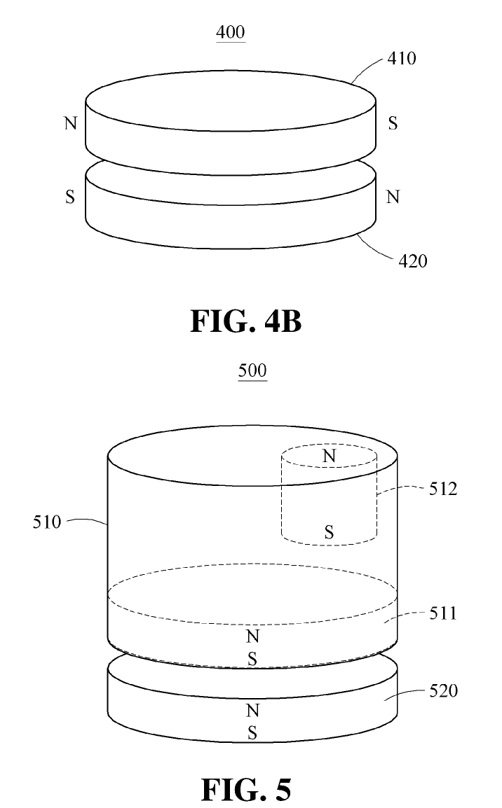

FIGS. 4a and 4b are diagrams illustrating another example of an input device using a magnetic field according to an example embodiment.

Referring to FIG. 4a, an input device 400 includes a movable magnetic portion 410 and a stationary magnetic portion 420 that are vertically magnetized. Dissimilar to a spherical movable magnetic portion, for example, the spherical movable magnetic portion 721 illustrated in FIG. 7, the movable magnetic portion 410 may be a coin-shaped magnetic portion.

When a user pushes the coin-shaped movable magnetic portion 410 with a finger of the user and such, an angle may not be changed dissimilar to a spherical magnetic portion, and the entire movable magnetic portion 410 may be pushed and move in parallel to the stationary magnetic portion 420. By such a movement of the movable magnetic portion 410, a magnetic field change pattern to be transferred to an electronic device may be generated. The electronic device may detect the magnetic field change pattern, and thus identify a direction and a distance of the movement of the movable magnetic portion 410.

Both the movable magnetic portion 410 and the stationary magnetic portion 420 may not necessarily be a magnet, and one of the movable magnetic portion 410 and the stationary magnetic portion 420 may be a magnet and the other may be a ferromagnetic body.

Referring to FIG. 4b, an input device 400 includes a movable magnetic portion 410 and a stationary magnetic portion 420 that are horizontally magnetized. Dissimilar to a spherical movable magnetic portion, for example, the spherical movable magnetic portion 721 illustrated in FIG. 7, the movable magnetic portion 410 may be a coin-shaped magnetic portion.

An electronic device may simultaneously identify a movement of a joystick-type input device having a 2 degrees of freedom (DoF) and a movement of a dial-type input device having a 1 DoF, through a triaxial magnetic field sensor. That is, the electronic device may identify a movement of at least one input device having a sum of DoFs less than or equal to a dimensionality of a sensor embedded in the electronic device. In addition, various types of input devices, for example, a joystick-type input device, a dial-type input device, and a button-type input device, may be attached to or detached from a single stationary magnetic portion 420 to be used.

FIG. 5 is a diagram illustrating still another example of an input device using a magnetic field according to an example embodiment.

Referring to FIG. 5, an inputter 500 includes a movable magnetic portion 510 and a stationary magnetic portion 520. The inputter 500 may be a dial-type device of which the movable magnetic portion 510 rotates in parallel to a plane to which the stationary magnetic portion 520 is attached.

The movable magnetic portion 510 includes a first magnetic body 511 and a second magnetic body 512, and may rotate on a central axis of the stationary magnetic portion 520. The first magnetic body 511 may be vertically magnetized similarly to the stationary magnetic portion 520 and disposed to share the central axis with the stationary magnetic portion 520, and have a centrally regressive characteristic based on a magnetic force with the stationary magnetic portion 520.

The second magnetic body 512 may be vertically magnetized similarly to the stationary magnetic portion 520, and disposed not to share the central axis with the stationary magnetic portion 520. That is, the second magnetic body 512 may be disposed in the movable magnetic portion 510 not to be symmetrical to the central axis of the stationary magnetic portion 520.

When the movable magnetic portion 510 rotates on the central axis of the stationary magnetic portion 520 by a user, a magnetic field change pattern generated by the second magnetic body 512 may be transferred to the electronic device. The electronic device may then detect the magnetic field change pattern, and identify a rotational movement of the movable magnetic portion 510.

In a case in which the vertically magnetized movable first magnetic body 511 is provided as illustrated in FIG. 5, there may be a three-dimensional (3D) movement including a two-dimensional (2D) movement of the movable magnetic portion 510 moving in parallel with respect to the stationary magnetic portion 520 as illustrated in FIG. 4a and a one-dimensional (1D) movement based on a central axis of the movable magnetic portion 510. A magnetic field change pattern generated by such a 3D movement may be transferred to the electronic device, and the electronic device may detect such a magnetic field change pattern through a triaxial magnetic field sensor. Thus, the electronic device may identify the 3D movement of the movable magnetic portion 510.

According to example embodiments, various types of input devices including a conductive material and/or a magnetic portion are described with reference to FIGS. 1 through 5. An input device may generate an electrical property change or a magnetic field change pattern that is generated by an operation of a user, and an electronic device may identify such an electrical property change or a magnetic field change pattern to perform a certain operation corresponding to the identified electrical property change or the identified magnetic field change pattern.

For example, the user may input a preset pattern to the electronic device through the input device. For example, when the user inputs a preset pattern (e.g., a pattern of moving upwards, upwards, downwards, leftwards, leftwards, and then rightwards) to the electronic device through a joystick-type input device, the electronic device may identify the input pattern and then unlock the electronic device. The electronic device may verify or authenticate the user through the input pattern, and perform the unlocking. The forgoing may also be applied to a case in which the user inputs a preset pattern (e.g., a combination of rotation angles of dials) to the electronic device through a dial-type input device. Further, the foregoing may also be applied to a case in which the user performs an act of swinging, in a certain pattern, a permanent magnet over the electronic device.

Here, the electronic device is not limited to a smartphone, and thus the electronic device used herein may include various devices, for example, an electronic door lock.

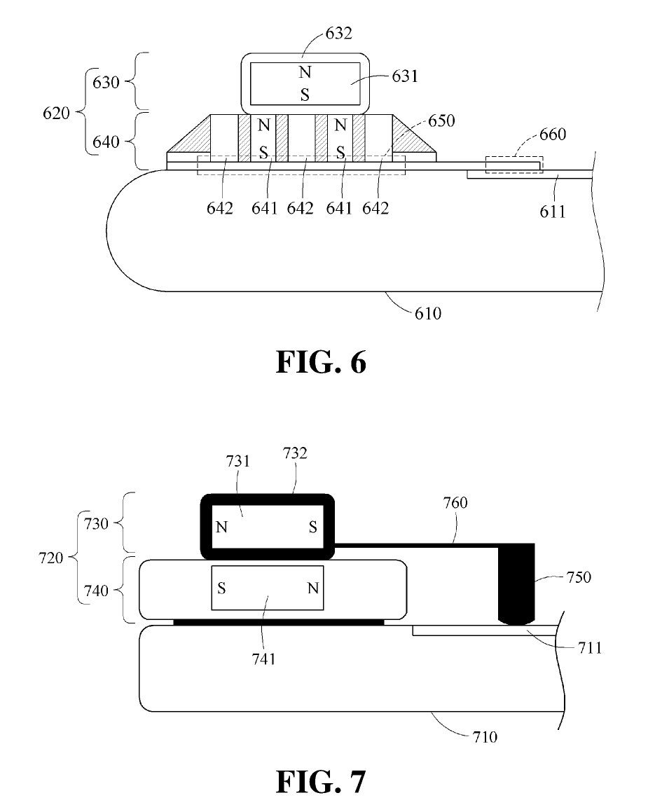

FIG. 6 is a diagram illustrating an example of an input device further including an inputter according to an example embodiment.

Referring to FIG. 6, an input device includes a first conductive material 650, a second conductive material 660, and an inputter 620.

The inputter 620 includes a movable magnetic portion 630 and a stationary magnetic portion 640. Both the movable magnetic portion 630 and the stationary magnetic portion 640 are devices having magnetism or magnetic properties, for example, a magnet, a ferromagnetic body, and the like.

The movable magnetic portion 630 is a portion of which a movement is controlled by a user, and corresponds to the handle portion 223 illustrated in FIG. 2. The movable magnetic portion 630 includes a first magnetic body 631 and a first conductive body 632. According to an example embodiment, the first magnetic body 631 may be vertically magnetized to generate an attractive force with the stationary magnetic portion 640. The movable magnetic portion 630 may have a characteristic of mechanically returning to a most stable location, in the absence of an external force, based on a magnetic force with the stationary magnetic portion 640 that is induced by the first magnetic body 631. For example, the movable magnetic portion 630 may have a centrally regressive characteristic of being disposed at a central axis of the stationary magnetic portion 640 based on an attractive force with the stationary magnetic portion 640. The inputter 620 may provide the user with tactile feedback, by providing, the user who moves the movable magnetic portion 630 in a direction, with a force of the movable magnetic portion 630 returning to an original location. The user may then recognize a direction and a force in and with which the user moves the movable magnetic portion 630 through the tactile feedback without a visual verification.

The first conductive body 632 may transfer a touch input by the user to a second magnetic body 341 and a second conductive body 642 of the stationary magnetic portion 640 being in contact with the first conductive body 632. When the user moves the movable magnetic portion 630 in a direction, the first conductive body 632 may come into contact with a portion of the second magnetic body 641 and the second conductive body 642 included in the stationary magnetic portion 640, and transfer the touch input by the user to the second magnetic body 641 and the second conductive body 642 being in contact with the first magnetic body 632.

The stationary magnetic portion 640 includes the second magnetic body 641 and the second conductive body 642. The stationary magnetic portion 640 may generate a magnetic force to attract the movable magnetic portion 630 through the second magnetic body 641. The second magnetic body 641 may be disposed in a circular shape at a center of the stationary magnetic portion 640 for the centrally regressive characteristic of the movable magnetic portion 630. The second magnetic body 641 may be provided as at least one magnetic body of which a surface includes a conductor. In a case in which the second magnetic body 641 is provided as a plurality of magnetic bodies, the magnetic bodies may be disposed separately from each other by insulators indicated by hatched lines in FIG. 6.

The second conductive body 642 may be a device configured to receive the touch input from the movable magnetic portion 630 and transfer the received touch input to the first conductive material 650 corresponding to the first conductive material 221 illustrated in FIG. 2, and may include, for example, aluminum and a conductor which is not a ferromagnetic body. When the movable magnetic portion 630 moves in a direction by the user, a portion of the second magnetic body 641 and the second conductive body 642 that comes into contact with the first conductive body 632 of the movable magnetic portion 630 may be changed, and thus a portion of the second magnetic body 641 and the second conductive body 642 that receives the touch input from the first conductive body 632 may also be changed. Here, a portion of the second magnetic body 641 and the second conductive body 642 that receives the touch input from the first conductive body 632 may transfer the received touch input to the first conductive material 650.

The first conductive material 650 may be disposed outside a touchscreen 611 of an electronic device 610, for example, on a housing of the electronic device 610, and generate an electrical property change based on a touch input by the user through the inputter 620.

The second conductive material 660 may be electrically connected to the first conductive material 650, and transfer the electrical property change to a predetermined location on the touchscreen 611.

The input device illustrated in FIG. 6 may be a device configured to transfer a touch input by the user to a certain area of the touchscreen 611 based on an intent of the user. The input device may embody the centrally regressive characteristic of the movable magnetic portion 630 based on a magnetic force to attract the movable magnetic portion 630 and the stationary magnetic portion 640 to each other, and transfer the touch input through a portion of the second magnetic body 641 and the second conductive body 642 corresponding to a location of the movable magnetic portion 630, and thus may effectively prevent the touch input from being transferred to a location that is not intended by the user.

FIG. 7 is a diagram illustrating another example of an input device further including an inputter according to an example embodiment.

Referring to FIG. 7, an inputter 720 included in an input device includes a movable magnetic portion 730 and a stationary magnetic portion 740. Both the movable magnetic portion 730 and the stationary magnetic portion 740 may be devices having magnetism or magnetic properties and include, for example, a magnet, a ferromagnetic body, and the like.

The movable magnetic portion 730 may be a portion of which a movement is controlled by a user, and correspond to the handle portion 223 illustrated in FIG. 2. The movable magnetic portion 730 includes a first magnetic body 731 and a first conductive material 732. The movable magnetic portion 730 may have a characteristic of mechanically returning to a most stable location, in the absence of an external force, based on a magnetic force with the stationary magnetic portion 740 that is induced by the first magnetic body 731. For example, the movable magnetic portion 730 may have a centrally regressive characteristic of being disposed at a central axis of the stationary magnetic portion 740 based on an attractive force with the stationary magnetic portion 740.

The stationary magnetic portion 740 includes a second magnetic body 741 and is attached to a housing of an electronic device 710. The stationary magnetic portion 740 may generate a magnetic force with the movable magnetic portion 730 through the second magnetic body 741.

A surface of the first magnetic body 731 of the movable magnetic portion 730 includes the first conductive material 732. The first conductive material 732 may generate an electrical property change based on a touch input by the user, and be connected to a second conductive material 750 through an arm 760.

For example, in a case of a touch sensor of a touchscreen 711 being capacitive, the arm 760 may be provided as a conductor and transfer the electrical property change generated in the first conductive material 732 to the second conductive material 750. For another example, in a case of the touch sensor of the touchscreen 711 being static, the arm 760 may be provided in a mechanical structure to transfer a constant magnitude of a pressure to the touchscreen 711 based on a movement of the movable magnetic portion 730 induced by the user.

The movable magnetic portion 730 may be designed not to rotate but move forwards, backwards, leftwards, and rightwards such that the arm 760 may transfer the touch input to the touchscreen 711 while moving in parallel to the movable magnetic portion 730. Through such a structure, the electronic device 710 may identify the touch input by the user based on the electrical property change transferred to the touchscreen 711. In a case in which the first magnetic body 731 included in the movable magnetic portion 730 and the second magnetic body 741 included in the stationary magnetic portion 740 are horizontally magnetized or the first magnetic body 731 and the second magnetic body 741 that are vertically magnetized are not in a circular form, a rotational movement of the movable magnetic portion 730 may be restricted.

Although not illustrated in FIG. 7, the inputter 720 may further include a rail structure to prevent a rotation of the arm 760. The rail structure may include two rails, which may one-dimensionally move with respect to respective axes that are perpendicular to each other. The movable magnetic portion 730 may two-dimensionally move based on the rail structure, and thus a rotation of the arm 760 extended from the movable magnetic portion 730 at a fixed angle may be restricted thereby.

However, in a case in which the arm 760 connecting the first conductive material 732 and the second conductive material 750 is provided as a plurality of arms, or the arm 760 is connected to a plurality of second conductive materials 750, the electronic device 710 may identify a rotation of the movable magnetic portion 730, in addition to a movement of the movable magnetic portion 730, based on a plurality of electrical property changes transferred to the touchscreen 711.

Although the arm 760 is illustrated as a reversed L-shaped structure in FIG. 7, a shape of the arm 760 is not limited to the illustrative example, and the arm 760 may also be designed to be a flattened U-shaped structure. Through such a flattened U-shaped arm, a touch input by the user to an inputter disposed on a back face of the electronic device 710 may be transferred to the touchscreen 711.

Although the first magnetic body 731 and the second magnetic body 741 are illustrated as being horizontally magnetized in FIG. 7, such a horizontal magnetization is provided merely as an illustrative example, and a form of the magnetization of the first magnetic body 731 and the second magnetic body 741 is not limited to the illustrative example. As necessary, the first magnetic body 731 and the second magnetic body 741 may be vertically magnetized to be affected by an attractive force therebetween. Further, each of the first magnetic body 731 and the second magnetic body 741 may include at least one or two sub magnetic bodies.

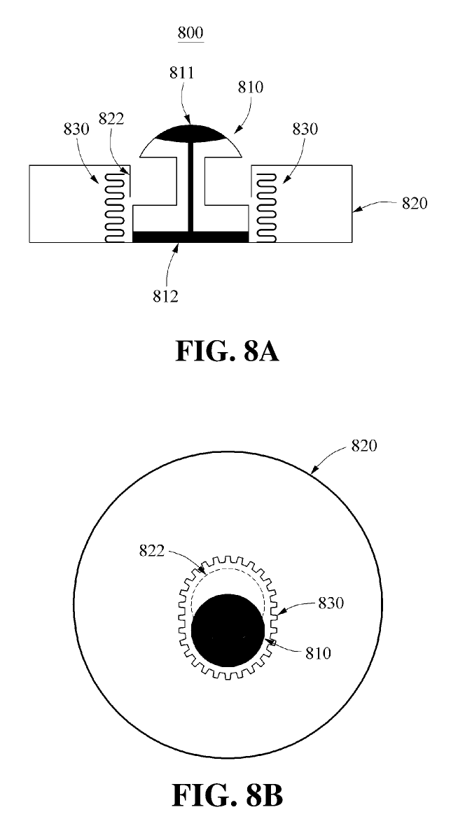

FIGS. 8a and 8b are diagrams illustrating an example of an inputter included in an input device according to an example embodiment.

FIG. 8a is a cross-sectional view of an inputter 800 including a movable element 810, a stationary element 820, and a spring 830.

The movable element 810 includes a first conductive body 811 and a second conductive body 812. The first conductive body 811 may be a portion disposed at an upper end of the movable element 810, and correspond to a portion to be touched by a user. The second conductive body 812 may be a portion disposed at a lower end of the movable element 810 and electrically connected to the first conductive body 811, and may transfer, to the stationary element 820, a touch input by the user to the first conductive body 811.

The stationary element 820 includes a guide 822. At a lower end of the stationary element 820, the first conductive material 221 illustrated in FIG. 2 may be disposed. Thus, the touch input transferred from the second conductive body 812 may be transferred to the first conductive material 221.

The spring 822 may be disposed around the movable element 810 and the guide 822 to allow the movable element 810 to return to a central axis of the inputter 800. The spring 822 may be stretched in length and contracted to be an original length based on a movement of the movable element 810 in a direction by the user, and thus the movable element 810 may have a centrally regressive characteristic.

FIG. 8b is a planar view of the inputter 800 including the movable element 810, the stationary element 820, and the spring 822.

Due to a movement of the movable element 810 in a direction by the user, a distance between the movable element 810 and the guide 822 may increase, and the spring 822 may be stretched in length in a movement direction of the movable element 810. Due to a characteristic of the spring 822 being contracted to be the original length, the movable element 810 may provide the user with tactile feedback, which is a force affecting in an opposite direction of the movement direction of the movable element 810. Thus, the user may recognize a direction and a force in and with which the user moves the movable element 810 through the tactile feedback without a visual verification.

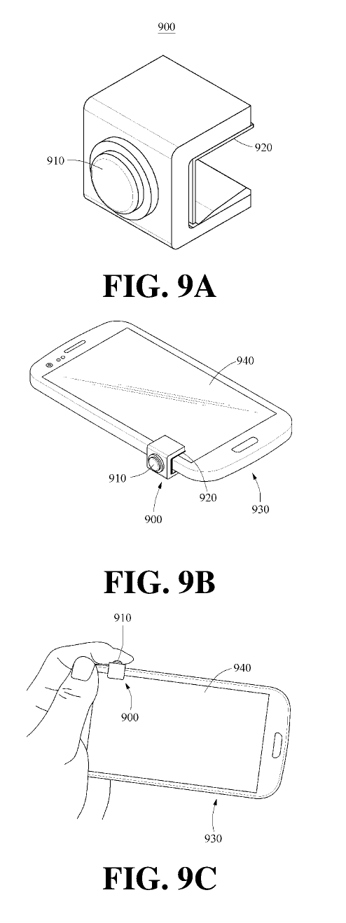

FIGS. 9a through 9c are diagrams illustrating an example of an operation method of an input device according to an example embodiment.

FIG. 9a illustrates an input device 900 including an inputter 910, a first conductive material, and a second conductive material 920. The first conductive material and the second conductive material 920 may be electrically connected. The first conductive material may be disposed on an inner face of the input device 900 that corresponds to the inputter 910.

A user may not need to touch directly the first conductive material that is extended outside a touchscreen. By designing the inputter 910 as a button configured to return to an original location by a spring, similarly to a mechanical button switch, and also provided with a conductive material, the inputter 910 may come into contact with the first conductive material when the user pushes the inputter 910, and thus an electrical property change that is generated by a touch input by the user may be transferred to the touchscreen through a connection of the user—the inputter 910—the first conductive material—the second conductive material 920.

In addition, noise may occur in the electrical property change based on a physical structure of the first conductive material and the second conductive material, for example, a size, an area, and a length thereof. In such a case, accuracy of the electrical property change to be transferred to the touchscreen may be improved by electrically connecting or not connecting the second conductive material to a ground portion of an electronic device, for example, a back face of the electronic device, in response to a touch input by the user. In a case in which the back face of the electronic device is provided as a conductor, the first conductive material may be connected to the back face of the electronic device based on whether a touch is input by the user or not, and thus it is possible to effectively prevent noise from occurring in the electrical property change based on a physical structure of the first conductive material.

Here, a method of electrically connecting the back face of the electronic device and the first conductive material through a touch input by the user may include a method of connecting the back face of the electronic device that is insulated by a nonconductor and the first conductive material through a portion of a body of the user, for example, a finger of the user, based on a fact that skin of the user is conductive. Also, such an electrically connecting method may include a method of electrically connecting the back face of the electronic device to one of both ends of a button-type electric switch and electrically connecting the first conductive material to the other end, and electrically connecting the back face of the electronic device and the first conductive material when the electric switch is turned on by the user. In such a method, skin of the user may not be used as a conductor, and the back face of the electronic device and the first conductive material may be electrically connected through an operation of turning on the electric switch by the user. Also, the electrically connecting method may include a method of designing an input device as a movable structure to dispose a second conductive material of the input device on a touchscreen without connecting the second conductive material to the touchscreen when a force is not applied to the input device, and electrically connect the back face of the electronic device and the touchscreen when a force is applied to the input device by the user and the second conductive material of the input device thus comes into contact with the touchscreen.

FIG. 9b illustrates an input device 900 that is mounted to an electronic device 930. FIG. 9c illustrates an example of how an input device 900 being mounted to an electronic device 930 receives a touch input from a user.

The input device 900 may be disposed to receive an input from a user through a button on a side face of the electronic device 930 on which a touchscreen is not provided, and thus be used as a shoulder button provided in, for example, a gamepad.

Although not illustrated in FIGS. 9b and 9c, the second conductive material may be disposed at an edge of a touchscreen 940 on which the input device 900 is installed, and also extended to a location of the touchscreen 940 to allow a touch input by the user to be transferred to the location.

That is, the second conductive material 920 may be connected to the first conductive material through a deformable conductor such as a wire, and thus attached to a portion desired by the user, which is not the edge of the touchscreen 940. A virtual button corresponding to each of various functions may be displayed at a location on the touchscreen 940. The virtual button may be used without a need to change contents displayed on the touchscreen 940, by disposing the second conductive material 920 at the location at which the virtual button is displayed, fixing the input device 900 onto the side face of the electronic device 930, and attaching the second conductive material 920 onto the touchscreen 940.

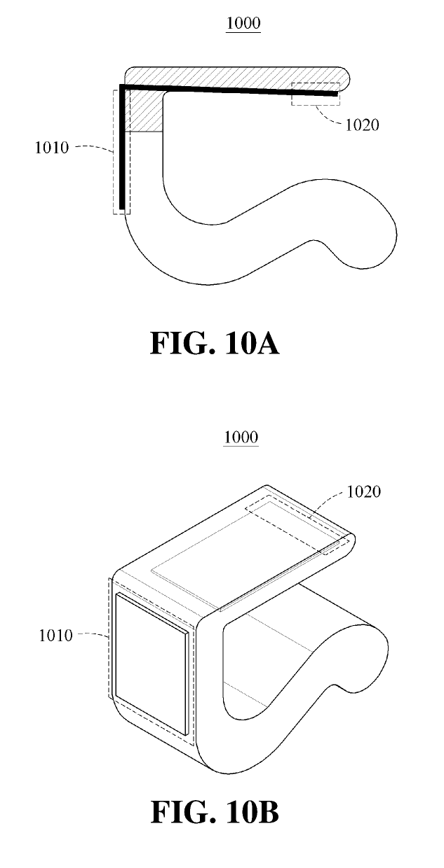

FIGS. 10a and 10b are diagrams illustrating another example of an operation method of an input device according to an example embodiment.

FIG. 10a illustrates an input device 1000 of another type that includes a first conductive material 1010 and a second conductive material 1020. In the input device 1000 illustrated in FIG. 10a, an electronic device may be disposed between a portion indicated by hatched lines and a portion without hatched lines.

The portion of the input device 1000 that is indicated by hatched lines may be provided as a transparent conductor, for example, an ITO patterned transparent plastic or glass, and thus transfer an electrical property change generated in the first conductive material 1010 to the second conductive material 1020 being in contact with a touchscreen, while not obstructing a view or a visual field of a user. The portion of the input device 1000 without hatched lines is a portion that does not obstruct the view of the user, and may be provided as a material that is not transparent. In addition, a nonconductor such as a general-type transparent plastic and glass, which is not a conductor, may be used for the portion indicated by hatched lines, and also a thin transparent conductive film, for example, an ITO film, that is indicated in black in FIG. 10a may be used as a first conductive material and a second conductive material.

FIG. 10b is a perspective view of the input device 1000 including the first conductive material 1010 and the second conductive material 1020.

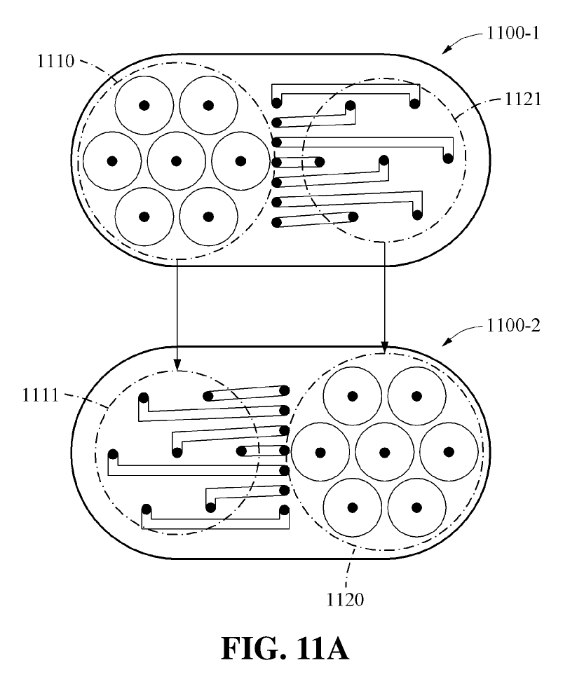

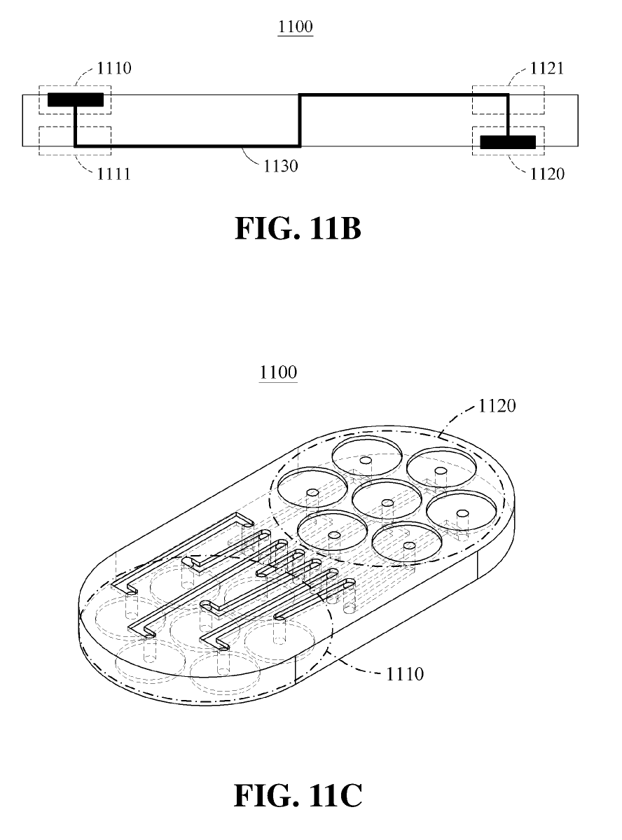

FIGS. 11a through 11c are diagrams illustrating still another example of an operation method of an input device according to an example embodiment.

FIG. 11a illustrates a front face 1100-1 and a back face 1100-2 of an input device 1100.

A first conductive material 1110 may be disposed outside a touchscreen of an electronic device, and generate an electrical property change based on a touch input by a user. An inputter configured to receive an instruction on an object movement direction indicated on the touchscreen may be disposed on the first conductive material 1110.

The first conductive material 1110 may be electrically connected to a second conductive material 1120. In detail, the first conductive material 1110 disposed on the front face 1100-1 may be electrically connected to a first area 1111 disposed on the back face 1100-1 through a through hole, and the first area 1111 may be electrically connected to a second area 1121 through an electric wire on the back face 1100-2, a through hole disposed at a center of the electronic device, and an electric wire on the front face 1100-1. The second area 1121 may be electrically connected to the second conductive material 1120 through a through hole. The second conductive material 1120 may be electrically connected to the touchscreen of the electronic device.

The input device 1100 may be designed using a transparent material, and an electric wire included in the input device 1100 may be designed using a transparent conductor, for example, an ITO patterned transparent film or glass. Thus, it is possible to minimize an area of a view of the user that may be occluded or obstructed by the input device 1100.

FIG. 11b is a cross-sectional view of the input device 1100, and FIG. 11c is a perspective view of the input device 1100.

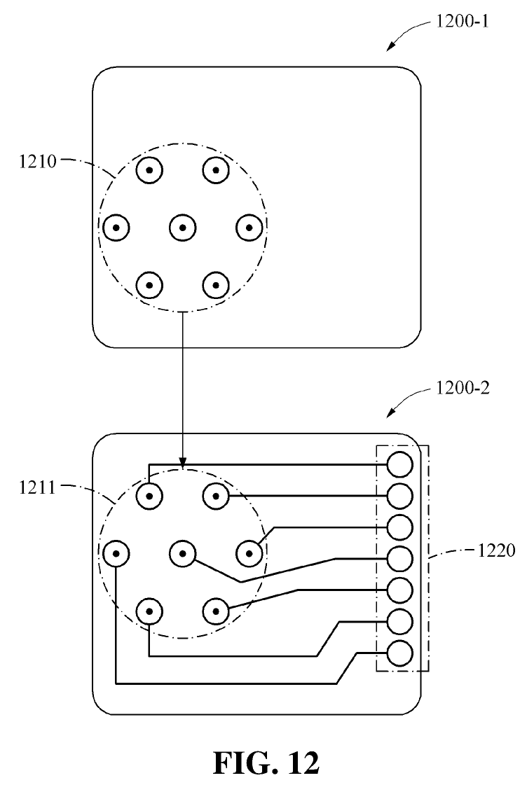

FIG. 12 is a diagram illustrating yet another example of an operation method of an input device according to an example embodiment.

FIG. 12 illustrates a front face 1200-1 and a back face 1200-2 of an input device 1200.

A first conductive material 1210 may be disposed outside a touchscreen of an electronic device, and generate an electrical property change based on a touch input by a user. An inputter configured to receive an instruction on an object movement direction indicated on the touchscreen may be disposed on the first conductive material 1210.

The first conductive material 1210 may be electrically connected to a second conductive material 1220. In detail, the first conductive material 1210 disposed on the front face 1200-1 may be electrically connected to an area 1211 disposed on the back face 1200-1 through a through hole, and the area 1211 may be electrically connected to the second conductive material 1220 through an electric wire on the back face 1200-2. The second conductive material 1220 may be electrically connected to the touchscreen of the electronic device.

The input device 1200 may be designed using a transparent material, and an electric wire included in the input device 1200 may be designed using a transparent conductor, for example, an ITO patterned transparent film or glass. Thus, it is possible to minimize an area a view of the user that may be occluded or obstructed by the input device 1200.

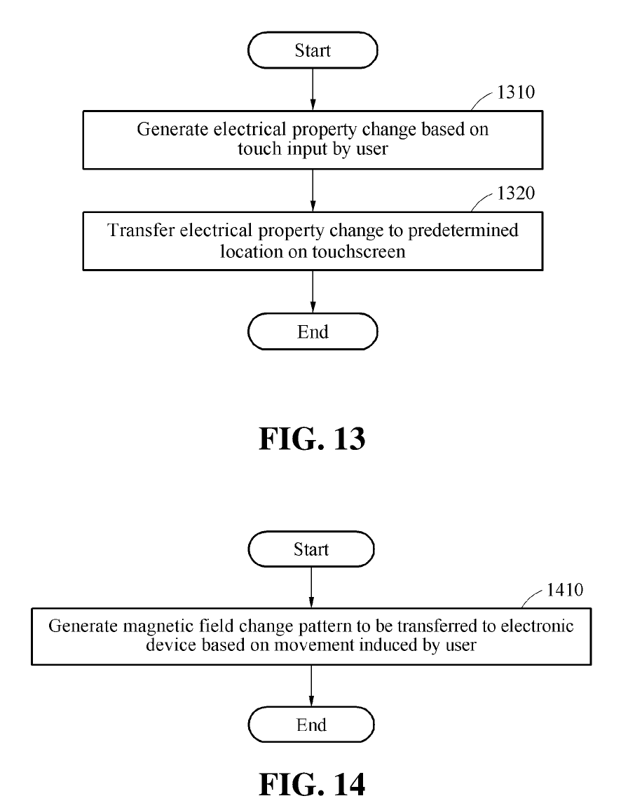

FIGS. 13 and 14 are flowcharts illustrating examples of an operation method of an input device according to an example embodiment.

Referring to FIG. 13, an operation method of an input device according to an example embodiment includes operation 1310 in which an electrical property change is generated, in a first conductive material disposed outside a touchscreen included in an electronic device, based on a touch input by a user, and operation 1320 in which a second conductive material configured to electrically connect the first conductive material and the touchscreen transfers the electrical property change to a predetermined location on the touchscreen.

Referring to FIG. 14, an operation method of an input device according to another example embodiment includes operation 1410 in which a magnetic field change pattern to be transferred to an electronic device is generated in a movable magnetic portion having a centrally regressive characteristic based on a magnetic force with a stationary magnetic portion fixed to the electronic device, based on a movement induced by a user.

The descriptions provided above with reference to FIGS. 1 through 12 may be applied to the operations described with reference to FIGS. 13 and 14, and thus a more detailed and repeated description is omitted here for brevity and clarity.

The units described herein may be implemented using hardware components and software components. For example, the hardware components may include microphones, amplifiers, band-pass filters, audio to digital convertors, non-transitory computer memory and processing devices. A processing device may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor or any other device capable of responding to and executing instructions in a defined manner The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums. The non-transitory computer readable recording medium may include any data storage device that can store data which can be thereafter read by a computer system or processing device.

Example embodiments include non-transitory computer-readable media including program instructions to implement various operations embodied by a computer. The media may also include, alone or in combination with the program instructions, data files, data structures, tables, and the like. The media and program instructions may be those specially designed and constructed for the purposes of example embodiments, or they may be of the kind well known and available to those having skill in the computer software arts. Examples of non-transitory computer-readable media include magnetic media such as hard disks, floppy disks, and magnetic tape; optical media such as CD ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter. The described hardware devices may be configured to act as one or more software modules in order to perform the operations of the above-described example embodiments, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. An input device corresponding to an electronic device, the input device comprising a movable magnetic portion having a centrally regressive characteristic based on a magnetic force with a stationary magnetic portion fixable to the electronic device, and configured to generate a magnetic field change pattern to be transferred to the electronic device based on a movement induced by a user.

12. The input device of claim 11, wherein the stationary magnetic portion is a magnetic portion attached to a housing of the electronic device or a magnetic portion embedded in the electronic device.

13. The input device of claim 1, wherein the movable magnetic portion is configured to oscillate with respect to the stationary magnetic portion based on the movement induced by the user and to generate the magnetic field change pattern based on the oscillation.

14. The input device of claim 11, wherein the movable magnetic portion and the stationary magnetic portion are disposed in parallel to each other, and vertically or horizontally magnetized to generate an attractive force therebetween.

15. The input device of claim 11, wherein the movable magnetic portion includes:
a first sub-magnetic portion configured to share a central axis with the stationary magnetic portion; and
a second sub-magnetic portion configured not to share a central axis with the stationary magnetic portion,
wherein the movable magnetic portion is configured to generate the magnetic field change pattern based on a rotational movement of the second sub-magnetic portion with respect to the stationary magnetic portion.

16. (canceled)

17. (canceled)

18. (canceled)

19. An electronic device comprising:
a sensor configured to sense a magnetic field change pattern generated in an input device based on a movement induced by a user; and
a processor configured to control an operation of the electronic device based on the magnetic field change pattern,
wherein the input device includes a movable magnetic portion having a centrally regressive characteristic based on a magnetic force with a stationary magnetic portion fixable to the electronic device.

20. The electronic device of claim 19, wherein, when the magnetic field change pattern corresponds to a preset pattern input by the user, the processor is configured to unlock the electronic device based on the magnetic field change pattern.

21. The electronic device of claim 20, wherein the preset pattern includes at least one of an object movement direction indicated on a touchscreen of the electronic device, a rotation of the movable magnetic portion with respect to the stationary magnetic portion, or a location change of the movable magnetic portion with respect to the stationary magnetic portion.

22. (canceled)

23. (canceled)

24. (canceled)

25. An operation method of an input device corresponding to an electronic device, the operation method comprising generating, by a movable magnetic portion having a centrally regressive characteristic based on a magnetic force with a stationary magnetic portion fixable to the electronic device, a magnetic field change pattern to be transferred to the electronic device, based on a movement induced by a user.

26. The operation method of claim 18, wherein the generating of the magnetic field change pattern comprises generating the magnetic field change pattern based on the movable magnetic portion configured to oscillate with respect to the stationary magnetic portion based on the movement induced by the user.

27. A non-transitory computer-readable medium comprising a program for instructing a computer to perform the operation method of claim 25.

28. The input device of claim 11, wherein the stationary magnetic portion is attachable and detachable to a side face or a bezel of the electronic device.

29. The input device of claim 11, wherein the movable magnetic portion has the centrally regressive characteristic to return to a central axis of the stationary magnetic potion based on the magnetic force with the stationary magnetic portion.

30. The input device of claim 11, wherein the movable magnetic portion is configured to generate the magnetic field change pattern to be transferred to the electronic device, when the movable magnetic portion deviates from a central axis of the stationary magnetic portion by the movement induced by the user and an angle formed with the stationary magnetic portion is changed.

31. The input device of claim 11, wherein a movement of the movable magnetic portion is identified by the electronic device detecting the magnetic field change pattern generated by the movable magnetic portion.

32. The input device of claim 11, further comprising a guide configured to restrict a movement of the movable magnetic portion such that the movable magnetic portion is not separated from the stationary magnetic portion by the movement induced by the user.

33. The input device of claim 11, wherein the movable magnetic portion is different from the stationary magnetic portion in shape, and is provided in a shape in which an angle formed with the stationary magnetic portion is changeable by the movement induced by the user.

34. The input device of claim 11, wherein the movable magnetic portion generates the magnetic field change pattern based on the movement in parallel with the stationary magnetic portion induced by the user.

35. The electronic device of claim 19, wherein the stationary magnetic portion is attachable and detachable to a side face or a bezel of the electronic device.

36. The electronic device of claim 19, wherein the movable magnetic portion has the centrally regressive characteristic to return to a central axis of the stationary magnetic portion based on the magnetic force with the stationary magnetic portion.
